(19) United States
(12) Patent Application Publication
(10) Pub. No.: US 2026/0223999 A1
(43) Pub. Date: Aug. 6, 2026

(54) ELECTRIC LUGGAGE PUSH ROD MECHANISM AND ELECTRIC LUGGAGE

(71) Applicant: WENJIANG LI, Guangyuan (CN)

(72) Inventor: WENJIANG LI, Guangyuan (CN)

(21) Appl. No.: 19/632,046

(22) Filed: Mar. 27, 2026

(30) Foreign Application Priority Data
Nov. 25, 2025 (CN) 202522501288.7

(51) Int. Cl. A45C 13/26; A45C 5/03; H02G 3/04

(52) U.S. Cl. CPC A45C 13/262; A45C 5/03; H02G 3/04; A45C 2013/267

(57) ABSTRACT

Provided are an electric luggage push rod mechanism and an electric luggage. The electric luggage push rod mechanism includes a pipe body provided at one end of an electric luggage body; a telescopic sleeve component provided inside the pipe body; a pull rod component provided on the telescopic sleeve component, where the pull rod component can be stretched upward outside the pipe body or contracted downward and placed on the pipe body through the telescopic sleeve component; and an electrical connection wire component that is movably provided between the pull rod component, the telescopic sleeve component, and the pipe body, with its upper end electrically connected to the pull rod component and its lower end electrically connected to the electric luggage body. The structure of this application is simple, and the traditional wireless signal transmission connection method is replaced by providing the electrical connection wire component.

### CROSS-REFERENCE TO RELATED APPLICATIONS

This application claims priority to Chinese Patent Application No. 202522501288.7, filed on Nov. 25, 2025, which is hereby incorporated by reference in its entirety.

### TECHNICAL FIELD

The present disclosure relates to the field of electric suitcase technologies, and in particular, to an electric luggage push rod mechanism and an electric luggage.

### BACKGROUND

With the increasing demand for travel and outgoing, suitcases are widely used as important travel tools. Traditional suitcases only have storage functions, and users need to manually push and pull them, especially when carrying heavy loads or when the suitcase is large, pushing and pulling the suitcase becomes very laborious. In recent years, smart suitcases with electric drive functions have emerged in the market. However, there are still many shortcomings in automatic control, user convenience, and safety of such suitcases. For example, the existing trolley part and luggage compartment are controlled and connected through wireless signal transmission, but this control method is not stable and is easily affected by external environmental interference, resulting in asynchronous, delayed, and even ineffective situations, seriously affecting the user experience.

Therefore, designing an electric intelligent luggage with high stability has become an urgent technical problem to be solved.

### SUMMARY

In order to overcome the shortcomings of existing technology, the present disclosure provides an electric luggage push rod mechanism and an electric luggage.

The technical solution adopted by the present disclosure to solve its technical problem is as follows.

An electric luggage push rod mechanism, including:
a pipe body, which is provided at one end of the electric luggage body;
a telescopic sleeve component, which is sleeved inside the pipe body;
a pull rod component, which is provided on the telescopic sleeve component, where the pull rod component is configured to be stretched upward outside the pipe body or contracted downward and placed on the pipe body through the telescopic sleeve component; and
an electrical connection wire component, which is movably provided between the pull rod component, the telescopic sleeve component, and the pipe body; an upper end of the electrical connection wire component is electrically connected to the pull rod component, and a lower end of the electrical connection wire component is electrically connected to the electric luggage body; the electrical connection wire component is configured to move up and down with the pull rod component and the telescopic sleeve component to elongate or curl.

In some embodiments of the present disclosure, the electrical connection wire component includes a straight connection wire component and a winding wire structure that are connected to each other, the straight connection wire component is placed inside the pull rod component, and the winding wire structure is placed between the telescopic sleeve component and the pipe body.

In some embodiments of the present disclosure, the winding wire structure includes a first winding wire component and a second winding wire component that are connected to each other, the first winding wire component is placed inside the telescopic sleeve component, and the second winding wire component is placed inside the pipe body, where the first winding wire component is configured to move upward with the pull rod component and extend inside the telescopic sleeve component, and the second winding wire component is configured to move upward with the telescopic sleeve component and move upwards and extend inside the pipe body.

In some embodiments of the present disclosure, a lower end of the pull rod component is further provided with a first limit member, and a lower end of the straight connection wire component passes through the first limit member and is connected to the first winding wire component.

In some embodiments of the present disclosure, a lower end of the telescopic sleeve component is further provided with a second limit member, and a lower end of the first winding wire component passes through the second limit member and is connected to the second winding wire component.

In some embodiments of the present disclosure, the pull rod component includes a connection sleeve rod that is slidably provided inside the telescopic sleeve component, and a pull rod handle that is provided at an upper end of the connection sleeve rod; the straight connection wire component is placed inside the connection sleeve rod and electrically connected to the pull rod handle.

In some embodiments of the present disclosure, one end of the pull rod handle is provided with a switch button.

In some embodiments of the present disclosure, the pull rod handle is further provided with a gear adjustment component.

In some embodiments of the present disclosure, a display component is provided on the pull rod handle.

In some embodiments of the present disclosure, an electric luggage is provided, which includes an electric luggage body, one end of the electric luggage body is provided with the electric luggage push rod mechanism as described above.

The beneficial effects of the present disclosure are: the structure of the present application is simple, and the traditional wireless signal transmission connection method is replaced by providing the electrical connection wire component, which is stable and greatly reduces the interference of the external environment on the use of the luggage. At the same time, the electrical connection wire component can move up and down with the pull rod component and the telescopic sleeve component to elongate or unwind, without affecting the normal stretching or shrinking of the pull rod, rendering it practical and convenient, and greatly improving the stability of use.

### BRIEF DESCRIPTION OF DRAWINGS

In order to provide a clearer explanation of the technical solution in the embodiments of the present application, a brief introduction will be given to the drawings required for the description of the embodiments. It is obvious that the drawings described below are only some embodiments of the present application. For those skilled in the art, other drawings can be obtained based on these drawings without creative work.

FIG. 1 is a schematic structural diagram of an electric luggage push rod mechanism according to an embodiment of the present disclosure.

FIG. 2 is an exploded structural view of the electric luggage push rod mechanism according to an embodiment of the present disclosure.

FIG. 3 is a schematic structural diagram of electric luggage according to an embodiment of the present disclosure.

### DESCRIPTION OF EMBODIMENTS

The technical solution of the present disclosure will be described in detail below with reference to the accompanying drawings and embodiments.

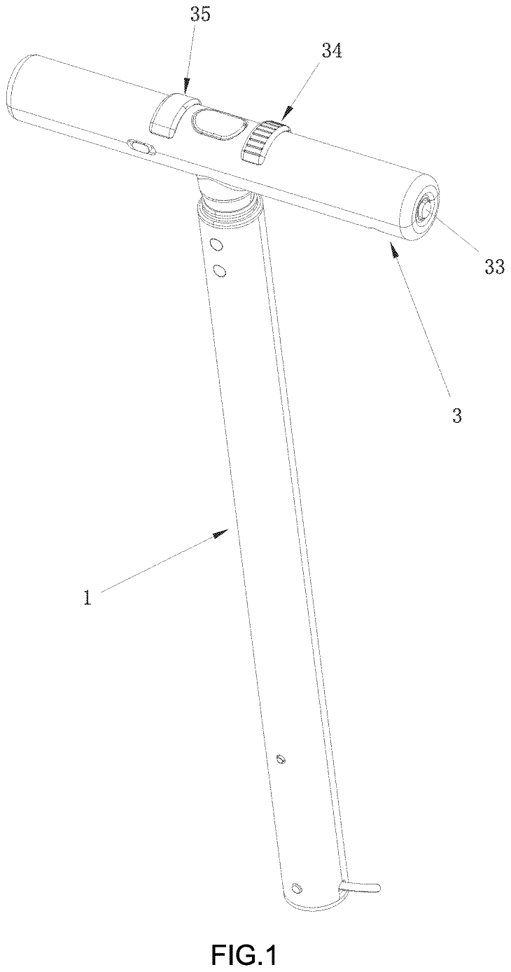

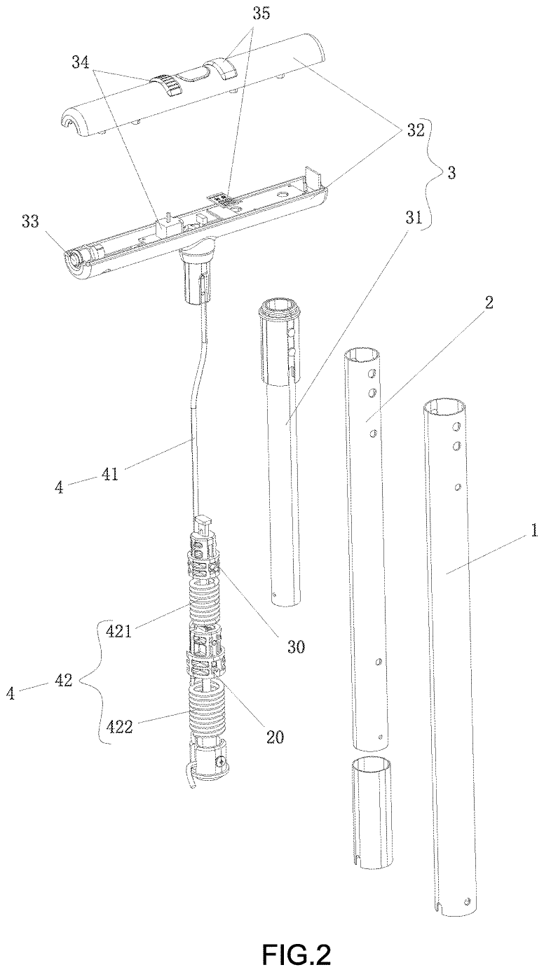

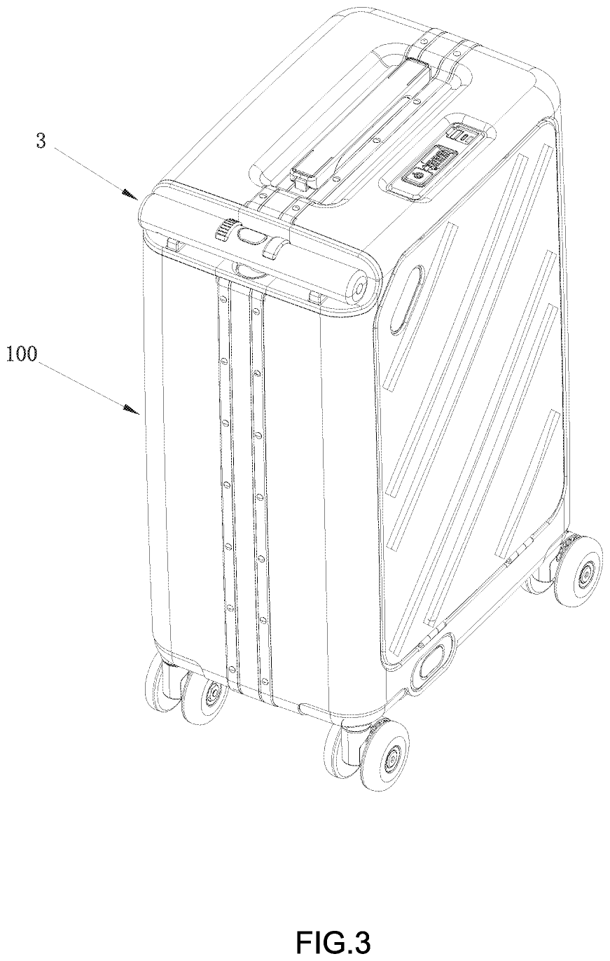

As shown in FIGS. 1 to 3, an embodiment of the present application provides an electric luggage, including an electric luggage body 100, one end of the electric luggage body 100 is provided with an electric luggage push rod mechanism.

The electric luggage push rod mechanism includes:
a pipe body 1, which is provided on one end of the electric luggage body 100;
a telescopic sleeve component 2, which is sleeved inside the pipe body 1;
a pull rod component 3, which is provided on the telescopic sleeve component 2, where the pull rod component 3 can be stretched upward outside the pipe body 1 or contracted downward and placed on the pipe body 1 through the telescopic sleeve component 2; and
an electrical connection wire component 4, which is movably provided between the pull rod component 3, the telescopic sleeve component 2, and the pipe body 1. Its upper end is electrically connected to the pull rod component 3, and its lower end is electrically connected to the electric luggage body 100. The electrical connection wire component 4 can move up and down with the pull rod component 3 and the telescopic sleeve component 2 to elongate or unwind.

By replacing the traditional wireless signal transmission connection method with the setting of electrical connection wire component 4, the connection is stable and greatly reduces the interference of external environment on the use of the luggage. At the same time, the electrical connection wire component 4 can move up and down with the pull rod component 3 and the telescopic sleeve component 2 to stretch or roll, without affecting the normal stretching or contraction of the pull rod. It is practical and convenient, and the stability of use is greatly improved.

In an implementation mode, the electrical connecting wire component 4 includes a straight connection wire component 41 and a winding wire structure 42 that are interconnected. The straight connection wire component 41 is placed inside the pull rod component 3, and the winding wire structure 42 is placed between the telescopic sleeve component 2 and the pipe body 1.

In an implementation mode, the winding wire structure 42 includes a first winding wire component 421 and a second winding wire component 422 that are connected to each other. The first winding wire component 421 is placed inside the telescopic sleeve component 2, and the second winding wire component 422 is placed inside the pipe body 1. The first winding wire component 421 can move upward and extend inside the telescopic sleeve component 2 with the pull rod component 3, and the second winding wire component 422 can move upward and extend inside the pipe body 1 with the telescopic sleeve component 2.

When the pull rod component 3 needs to be adjusted for use, the pull rod component 3 is pulled upwards to it moves upward relative to the telescopic sleeve component 2. At this time, the straight connection wire component 41 follows the movement to pull the first winding wire component 421 to extend, ensuring connection stability and practical convenience. When the pull rod component 3 continues to pull upwards to drive the telescopic sleeve component 2 to move upwards, the first winding wire component 421 continues to follow and move after elongation, thereby further ensuring the stability of the connection and practical convenience of the second winding wire component 422. Otherwise, the corresponding roll up will be restored.

In an implementation mode, a lower end of the pull rod component 3 is further provided with a first limit member 30, and a lower end of the straight connection wire component 41 passes through the first limit member 30 and is connected to the first winding wire component 421.

A lower end of the telescopic sleeve component 2 is further provided with a second limit member 20, and a lower end of the first winding wire component 421 passes through the second limit member 20 and is connected to the second winding wire component 422.

By providing the first limit member 30 and the second limit member 20, the electrical connection wire component 4 can always be kept in the corresponding line position, further ensuring the stability of the connection and practical convenience.

In an implementation mode, the pull rod component 3 includes a connection sleeve rod 31 that is slidably provided into the telescopic sleeve component 2, and a pull rod handle 32 that is provided at an upper end of the connection sleeve rod 31. The straight connection wire component 41 is placed inside the connection sleeve rod 31 and electrically connected to the pull rod handle 32.

In an implementation mode, one end of the pull rod handle 32 is provided with a switch button 33. By placing the switch button 33 on one end of the pull rod handle 32, it is convenient for people to press to start or turn off.

In an implementation mode, the pull rod handle 32 is further provided with a gear adjustment component 34, it is convenient for people to control the speed during cycling.

In an implementation mode, the pull rod handle 32 is provided with a display component 35. It is convenient for people to directly understand specific information such as gear, speed, battery level, etc. during the cycling process.

In this embodiment, the switch button 33, the gear adjustment component 34, and the display component 35 are commonly used existing technologies in this field. This application provides a simple application and will not be described in detail here.

In summary, the embodiment of the present application replaces the traditional wireless signal transmission connection method with the setting of the electrical connection wire component 4, which provides stable connection and greatly reduces the interference of external environment on the use of the luggage. At the same time, the electrical connection wire component 4 can move up and down with the pull rod component 3 and the telescopic sleeve component 2 to stretch or roll, without affecting the normal stretching or contraction of the pull rod, rendering it practical and convenient, and greatly improving the stability of use.

The above description is only an embodiment of the present disclosure and does not limit the scope of the present disclosure. Any equivalent structure made using the specification and drawings of the present disclosure, or directly or indirectly applied in other related technical fields, is also included in the protection scope of the present disclosure.

What is claimed is:

1. An electric luggage push rod mechanism, comprising:
a pipe body, which is provided at one end of the electric luggage body;
a telescopic sleeve component, which is sleeved inside the pipe body;
a pull rod component, which is provided on the telescopic sleeve component, wherein the pull rod component is configured to be stretched upward outside the pipe body or contracted downward and placed on the pipe body through the telescopic sleeve component; and
an electrical connection wire component, which is movably provided between the pull rod component, the telescopic sleeve component, and the pipe body; an upper end of the electrical connection wire component is electrically connected to the pull rod component, and a lower end of the electrical connection wire component is electrically connected to the electric luggage body; the electrical connection wire component is configured to move up and down with the pull rod component and the telescopic sleeve component to elongate or curl.

2. The electric luggage push rod mechanism according to claim 1, wherein the electrical connection wire component comprises a straight connection wire component and a winding wire structure that are connected to each other, the straight connection wire component is placed inside the pull rod component, and the winding wire structure is placed between the telescopic sleeve component and the pipe body.

3. The electric luggage push rod mechanism according to claim 2, wherein the winding wire structure comprises a first winding wire component and a second winding wire component that are connected to each other, the first winding wire component is placed inside the telescopic sleeve component, and the second winding wire component is placed inside the pipe body,
wherein the first winding wire component is configured to move upward with the pull rod component and extend inside the telescopic sleeve component, and the second winding wire component is configured to move upward with the telescopic sleeve component and move upwards and extend inside the pipe body.

4. The electric luggage push rod mechanism according to claim 3, wherein a lower end of the pull rod component is further provided with a first limit member, and a lower end of the straight connection wire component passes through the first limit member and is connected to the first winding wire component.

5. The electric luggage push rod mechanism according to claim 3, wherein a lower end of the telescopic sleeve component is further provided with a second limit member, and a lower end of the first winding wire component passes through the second limit member and is connected to the second winding wire component.

6. The electric luggage push rod mechanism according to claim 2, wherein the pull rod component comprises a connection sleeve rod that is slidably provided inside the telescopic sleeve component, and a pull rod handle that is provided at an upper end of the connection sleeve rod;
the straight connection wire component is placed inside the connection sleeve rod and electrically connected to the pull rod handle.

7. The electric luggage push rod mechanism according to claim 6, wherein one end of the pull rod handle is provided with a switch button.

8. The electric luggage push rod mechanism according to claim 6, wherein the pull rod handle is further provided with a gear adjustment component.

9. The electric luggage push rod mechanism according to claim 6, wherein a display component is provided on the pull rod handle.

10. An electric luggage, comprising an electric luggage body, wherein one end of the electric luggage body is provided with the electric luggage push rod mechanism according to claim 1.
